(19) United States
(12) Patent Application Publication
(10) Pub. No.: US 2022/0324071 A1
(43) Pub. Date: Oct. 13, 2022

(54) APPARATUS AND METHOD FOR MOUNTING O-RING AND ROBOT

(71) Applicant: ABB Schweiz AG, Baden (CH)

(72) Inventors: Qi Lu, Shanghai (CN); Jiafan Zhang, Shanghai (CN); Hang Zhou, Xi'an, Shaanxi (CN)

(21) Appl. No.: 17/753,618

(22) PCT Filed: Sep. 25, 2019
(86) PCT No.: PCT/CN2019/107733

§ 371 Date: Mar. 9, 2022

(51) Int. Cl. B23P 19/08; B25B 27/00

(52) U.S. Cl. CPC B23P 19/084; B25B 27/0028

(57) ABSTRACT

Embodiments of the present disclosure provide an apparatus and method for mounting an O-ring to a work piece. The apparatus comprises a guiding component comprising a frustum portion arranged coaxially with a groove formed on an end surface of the work piece for receiving the O-ring, a large end face of the frustum portion arranged adjacent to the end surface; and an operation component adapted to drive the guiding component to rotate back and forth about a central axis of the guiding component, wherein a diameter of the large end face is substantially same as an inner diameter of the O-ring to allow the O-ring surrounding and eccentric to the frustum portion to slide into the groove with a rotation of the guiding component.

### FIELD

Embodiments of the present disclosure generally relate to a robot, and more specifically, to apparatuses and methods for mounting O-rings to a work piece.

### BACKGROUND

An O-ring, also known as a packing or a toric joint, is a mechanical gasket in the shape of a torus. It is a loop of elastomer with a round cross-section, designed to be seated in a groove and compressed during assembly between two or more parts, creating a seal at the interface. The O-ring may be used in static applications or in dynamic applications where there is relative motion between the parts and the O-ring.

O-rings are one kind of the most common seals used in machine design because they are inexpensive, easy to make, reliable. Under normal conditions, O-rings are assembled manually, which is inefficient and labor-intensive and significantly reduces the overall assembly efficiency of a work piece. In order to increase efficiency, the demand for automated assembly of O-rings is increasing. The automated assembly of O-rings involves feeding and mounting of O-rings.

Traditional O-ring auto-assembly methods are usually merely suitable for the O-ring mounting on an outer circumference of a shaft or an inner circumference of a hole. However, such methods cannot be applied to mounting the O-ring, particularly the flexible O-ring, in a groove on an end surface of a work piece, which is also widely used in the industry. For example, some O-rings in the joints of a manipulator robot are mounted in the groove on the end surface.

### SUMMARY

To address or at least partially address the above and other potential problems, embodiments of the present disclosure provide an apparatus for mounting an O-ring to a work piece.

In a first aspect, an apparatus for mounting an O-ring to a work piece is provided.

The apparatus comprises a guiding component comprising a frustum portion arranged coaxially with a groove formed on an end surface of the work piece for receiving the O-ring, a large end face of the frustum portion arranged adjacent to the end surface; and an operation component adapted to drive the guiding component to rotate back and forth about an axis of the guiding component, wherein a diameter of the large end face is substantially same as an inner diameter of the O-ring to allow the O-ring surrounding and eccentric to the frustum portion to slide into the groove with a rotation of the guiding component.

With the diameter of the large end face of the frustum portion being substantially same as the inner diameter of the O-ring, a part of the O-ring would lie on a bevel surface of the frustum portion after the O-ring is dropped on the work piece. At this time, it is only necessary to reciprocally rotate the guiding component, and the O-ring thereon would slid into the groove against the frictional force, thereby realizing the automotive mounting of the O-ring on an end surface of the work piece with a simple structure.

In some embodiments, the guiding component further comprises a gripped portion extending from the small end of the frustum portion, and the gripped portion is adapted to be gripped by the operation component to drive the guiding component. In this way, the guiding component can be gripped in a more convenient and stable manner.

In some embodiments, the operation component comprises a first gripping portion and a second gripping portion adapted to be driven to move towards each other to grip the gripped portion in a first posture of the operation component. With this arrangement, the gripping of operation component can be achieved more easily, for example, be achieved as an end effector of a robot.

In some embodiments, the operation component further comprises a roller arranged at a free end of each of the first and second gripping portions, and the operation component is operable to move from the first posture to a second posture where the roller presses across the groove and is operable to rotate upon movements of the first and second gripping portions towards each other, to cause the entire O-ring to be received in the groove. As a result, it can be ensured that the O-ring is well received in the groove.

In some embodiments, an operation surface of at least one of the first and second gripping portions for contacting the gripped portion is of a concave shape or a flat shape. With this arrangement, the guide member can be gripped more stably, thereby improving the reliability of the O-ring assembly.

In some embodiments, a slope of the frustum portion is configured to allow the O-ring that has been placed on the frustum portion to slide along the frustum portion against frictional force as the guiding component rotates back and forth. As a result, it can be ensured that the O-ring can slide into the groove when the guiding component rotates back and forth.

In some embodiments, the guiding component further comprises an aligning portion for aligning the guiding component with the work piece. In this way, the guiding component can be aligned with the work piece with the frustum portion coaxial with the groove more easily.

In a second aspect, a robot is provided. The robot comprises an end effector adapted to operate the apparatus as mentioned according to the first aspect above to mount an O-ring to a work piece. In this way, the mounting of the O-ring on the end face of work piece can be achieved with a robot, thereby improving efficiency and accuracy for mounting the O-ring.

In some embodiments, an operation component of the apparatus is a part of the end effector of the robot.

In a third aspect, a method for mounting an O-ring to a work piece is provided. The method comprises placing a guiding component on an end surface of the work piece, with a frustum portion arranged coaxially with a groove formed on the end surface and a large end face of the frustum portion arranged adjacent to the end surface; placing the O-ring to surround the frustum portion; and driving the guiding component by the operation component to rotate back and forth about an axis of the guiding component to cause the O-ring eccentric to the frustum portion to slide into the groove.

In some embodiments, the method further comprises removing the guiding component from the end surface after the O-ring is at least partially received in the groove; moving the operation component from a first posture to a second posture where a roller of the operation component presses across the groove; and moving the first and second gripping portions towards each other to rotate the roller to cause the entire O-ring to be received in the groove.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

The above and other objectives, features and advantages of the present disclosure will become more apparent through more detailed depiction of example embodiments of the present disclosure in conjunction with the accompanying drawings, wherein in the example embodiments of the present disclosure, same reference numerals usually represent same components.

FIG. 1 shows a front view and a side view of an O-ring;

FIG. 2 shows a perspective view of an apparatus for mounting an O-ring to a work piece according to embodiments of the present disclosure;

FIG. 3 shows a side view of a guiding component with an O-ring and a work piece according to embodiments of the present disclosure;

FIG. 4 shows a sectional side view of a guiding component with an O-ring and a work piece according to embodiments of the present disclosure;

FIG. 5 shows a side view of an operation component in a second posture according to embodiments of the present disclosure;

FIG. 6 shows a perspective view of an operation component in a first posture according to embodiments of the present disclosure; and

FIG. 7 shows a flowchart illustrating a method for mounting an O-ring to a work piece according to embodiments of the present disclosure.

Throughout the drawings, the same or similar reference symbols are used to indicate the same or similar elements.

### DETAILED DESCRIPTION

The present disclosure will now be discussed with reference to several example embodiments. It is to be understood these embodiments are discussed only for the purpose of enabling those skilled persons in the art to better understand and thus implement the present disclosure, rather than suggesting any limitations on the scope of the subject matter.

As used herein, the term “comprises” and its variants are to be read as open terms that mean “comprises, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be comprised below. A definition of a term is consistent throughout the description unless the context clearly indicates otherwise.

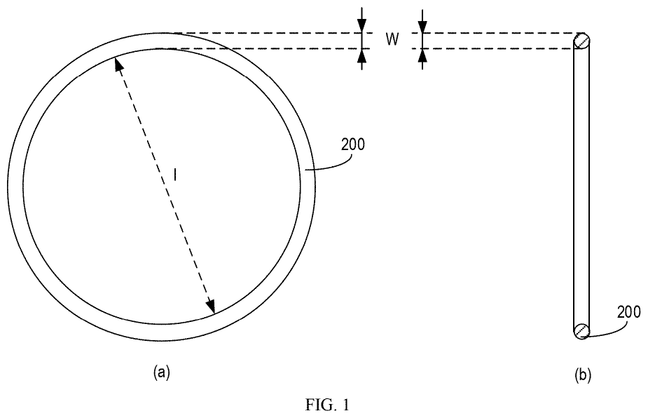

There are many sizes of O-rings used in the industry. FIG. 1 shows a front view and a side view of an O-ring 200. As shown, the O-ring 200 with certain elasticity has a wire diameter W and an inner diameter I. Generally, a ratio of the inner diameter I to the wire diameter W may reflect the deformation ability of the O-ring 200 to a certain extent. Specifically, the smaller the ratio, the harder to be deformed (refers to as “rigid O-ring”) and the larger the ratio, the more easily to be deformed (refers to as “flexible O-ring”).

Typically, to meet the requirements of the mating between different work pieces, an O-ring 200 can be mounted in a groove which is formed on an outer cylindrical surface, an inner cylindrical surface or an end surface of a work piece 300. Currently, there are solutions to allow the O-ring 200 to be mounted in the groove formed on the outer or inner cylindrical surface of a work piece 300 automatically, for example with a robot.

However, the O-ring 200 to be mounted in the groove formed on the end surface of the work piece 300 is typically a flexible O-ring, i.e., the ratio of the inner diameter I to the wire diameter W is large. In addition, compared to the groove formed on the outer or inner cylindrical surface, the groove formed on the end face tends to detach the O-ring 200 due to the lack of restriction to the O-ring 200. For the above reasons, it is a challenge to automate the assembly of the O-ring 200 into the groove on the end surface. Nowadays, at least some steps of processes for mounting the O-ring 200 into the groove of the end surface requires human intervention, resulting in low efficiency and accuracy.

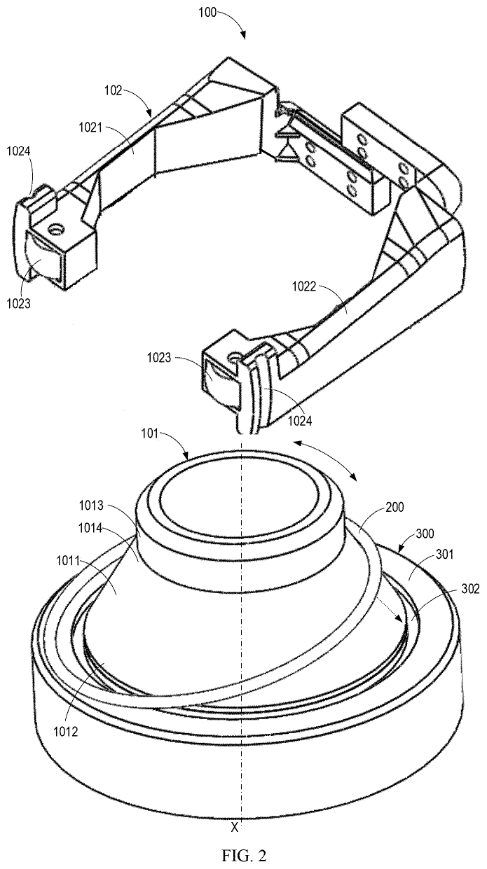

In order to improve efficiency and accuracy, embodiments of the present disclosure provide an apparatus 100 for mounting an O-ring 200 to a work piece 300. Now some example embodiments will be described with reference to FIGS. 2-6.

FIG. 2 shows a perspective view of the apparatus 100 for mounting the O-ring 200 to the work piece 300. As shown, generally, the apparatus 100 comprises a guiding component 101 and an operation component 102. The guiding component 101 comprises a frustum portion 1011 which allows the O-ring 200 that has been dropped thereon to slide into a groove 302 formed on the end surface 301 of the work piece 300. The frustum portion 1011 has a large end face 1012 arranged adjacent to the end surface 301.

The operation component 102 can drive the guiding component 101 to rotate back and forth about an axis X of the guiding component 101. In some embodiments, the operation component 102 may be operated by an end effector of a robot. In some alternative embodiments, the operation component 102 may be a part of the end effector of the robot, which will be discussed further below.

To facilitate the operation, in some embodiments, as shown in FIG. 2, the operation component 102 may comprise two gripping portions that can be driven to move towards each other to grip the gripped portion 1013. In the following, the two gripping portions are referred to as a first gripping portion 1021 and a second gripping portion 1022 for ease of discussion. The first and second gripping portion 1021, 1022 can grip the gripped portion 1013 when the operation component 102.

Besides a cylinder shape as shown in FIG. 2, the gripped portion 1013 may also have any suitable shape for gripping. For example, in some embodiments, a cross section of the gripped portion 1013 may be of an oval shape, a square shape, a rectangular shape, a pentagon shape, a hexagon shape, or any other polygon shapes.

In some embodiments, the operation component 102 as the end effector can operate the guiding component 101 or the O-ring 200 in at least two postures. That is, the operation component 102 can change its postures during the operation. For example, in a first posture as shown in FIG. 2, the operation component 102, which is in a horizontal orientation, can drive the guiding component 101 to rotate. When the Operation component 102 is in a second posture, the operation component 102, which is in a vertical orientation, may ensure the O-ring 200 to be well received in the groove 302, which will be discussed further below. With at least two postures of the operation component 102, the O-ring 200 can be picked up in various ways.

For example, in some embodiments, a wire body of the O-ring 200 can be clamped with the operation component 102 in either first or second posture to move to the position above the work piece 300. In some alternative embodiments, the O-ring 200 may also be picked up by being expanded from inside by the first and second gripping portions 1021, 1022 in the second posture. In those embodiments, slots 1024 may be formed on outer circumferences of the first and second gripping portions 1021, 1022 for partially receiving the O-ring 200 when the O-ring 200 is expanded, as shown in FIG. 2. In some further alternative embodiments, the O-ring 200 may also be picked up manually or by being sucked up and moved to the position above the work piece 300.

When the first and second gripping portions 1021, 1022 grip the gripped portion 1013 in the first posture, operation surfaces of the first and second gripping portions 1021, 1022 contact and squeeze the gripped portion 1013. In some embodiments, as shown in FIG. 2, at least one operation surface of the first and second gripping portions 1021, 1022 may have a concave shape to substantially match the shape of the gripped portion 1013 to facilitate gripping. A cross section of the concave shape may be any suitable shape such as trapezoidal or semi-circular or the like.

It is to be understood that the above embodiment where at least one operation surface of the first and second gripping portions 1021, 1022 may have a concave shape are merely for illustration, without suggesting any limitations as to the scope of the present disclosure. Any other suitable structures and/or arrangements are possible as well. For example, in some embodiments, at least one of the first and second gripping portions 1021, 1022 may also be of a plate shape. That is, the operation surface of the gripping portion may have a flat shape, resulting in low costs and high applicability. In some embodiments, the operation surface may have a surface structure to increase friction.

In some embodiments, to prevent damage of the gripped portion 1013 or the O-ring and improve the friction between the first and second gripping portions 1021, 1022 and the gripped portion 1013, an elastic member may be arranged on the operation surfaces. The elastic member can be made of rubber, silicon or the like.

As shown in FIGS. 2-4, the groove 302 which is arranged coaxially with the frustum portion 1011 is for receiving the O-ring 200 without deformation or with a minimums deformation. Specifically, an inner diameter of the O-ring 200 is substantially same as that of the groove 302. In the meantime, a diameter D of the large end face 1012 is substantially same as the inner diameter of the O-ring 200 or the groove 302. In this way, the O-ring 200 can be received in the groove 302 without deformation or with a minimums deformation.

In some embodiments, as shown in FIG. 4, to facilitate coaxial arrangement between the groove 302 and the frustum portion 1011, the guiding component 101 may comprise an aligning portion 1015 for aligning the guiding component 101 with the work piece 300. To this end, the aligning portion 1015 may be a portion that extends from the large end face 1012 along the axis X and may be inserted into an inner hole formed in the work piece 300. In this way, the guiding component 101 is aligned with the work piece 300, with the frustum portion 1011 coaxial with the groove 302.

It is to be understood that the above embodiment of aligning the guiding component 101 with the work piece 300 is merely for illustration, without suggesting any limitations as to the scope of the present disclosure. Any other suitable structures and/or arrangements are possible as well. For example, in some embodiments, the guiding component 101 may be aligned with the work piece 300 by inserting bumps formed on the large end face 1012 of the guiding component 101 into the corresponding slots formed on the end surface 301.

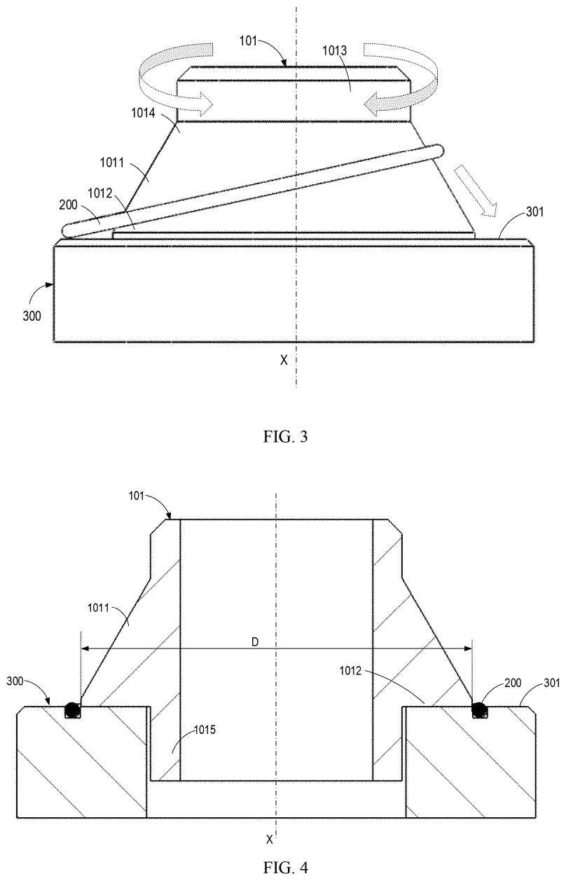

In operation, the O-ring 200 is dropped on the work piece 300 and the guiding component 101 as shown in FIG. 3 by an end effector of a robot. For example, in some embodiments, the end effector can be controlled to pick up the O-ring and move to a position over the guiding component 101.

Due to the guiding component 101, the O-ring 200 and groove 302 do not have to be strictly aligned in the longitudinal direction. That is, when preparing to drop the O-ring 200, the robot does not have to pay too much attention to the alignment between the O-ring 200 and the work piece 300. As long as the O-ring 200 can be dropped to surround the frustum portion 1011 and regardless of whether the dropped O-ring 200 and the frustum portion 1011 are coaxial, the end effector can be moved to any suitable position to drop the O-ring 200, thereby reducing operation difficulty and increasing efficiency.

In addition, this arrangement allows the robot to perform the required operations without too much precision, thereby reducing costs. For example, in some embodiments, the operation component 102 can be used as or be a part of an end effector of a robot to pick up and move the O-ring 200.

As mentioned above, the O-ring 200 and groove 302 do not have to be strictly aligned in the longitudinal direction when the O-ring 200 is ready to be dropped. As a result, after the O-ring 200 is dropped on the work piece 300, the O-ring 200 may surround but is eccentric to the frustum portion 1011, as shown in FIGS. 2 and 3. Because of friction between the O-ring 200 and the frustum portion 1011, a further movement of the O-ring 200 along the frustum portion 1011 under its gravity is prevented. In a sense, the dropped O-ring 200 and the frustum portion 1011 are connected via the friction therebetween.

In this event, the operation component 102 can drive the guiding component 101 to rotate back and forth about its central axis X. With the rotation of the operation component 102, the frictional connection between the O-ring 200 and the frustum portion 1011 is broken. As a result, under the gravity of the O-ring 200, a part of the O-ring 200 dropped on the frustum portion 1011 slides along the frustum portion 1011 and into the groove 302 eventually, as shown in FIGS. 3 and 4.

In addition to being rotatable about the central axis X, the guiding component 101 can also be driven to oscillate about an axis that is perpendicular to the central axis in some embodiments. The oscillation of the guiding component 101 can also break the friction between the O-ring 200 and the frustum portion 1011 to allow the O-ring 200 to slide along the frustum portion 1011 and into the groove 302 eventually. In some alternative embodiments, the rotation about the central axis X and the oscillation of the guiding component 101 may be performed simultaneously. In this way, it can be ensured that the O-ring 200 can slide into the groove 302.

It can be seen from the above that with the diameter of the large end face of the frustum portion 1011 being substantially same as the inner diameter of the O-ring 200, a part of the O-ring 200 would lie on a beveled surface of the frustum portion 1011 after the O-ring 200 is dropped on the work piece 300. At this time, it is only necessary to reciprocally rotate the guiding component 101, and the O-ring 200 thereon would slide into the groove 302 against the frictional force, thereby realizing the automotive mounting of the O-ring 200 on the end surface 301 of the work piece 300 with a simple structure. In this way, mounting efficiency and accuracy can be improved.

In some embodiments, to facilitate the sliding of the O-ring 200 along the frustum portion 1011, a slope of the frustum portion 1011 may be sized to allow the O-ring 200 to slide when the guiding component 101 rotates back and forth. The “slope” herein means a degree of inclination of the beveled surface of the frustum portion 1011. The slope should not be too large, otherwise it would not help the O-ring 200 to fall to surround the frustum portion 1011. In the meantime, the slope should not be too small, otherwise the O-ring may not slide with the rotation of the guiding component 101.

That is, the slope needs to be appropriately selected according to parameters such as surface roughness. In this way, the O-ring can easily be dropped to a proper position where the O-ring 200 surrounds the frustum portion 1011. In the meantime, the appropriately selected slope can facilitate the sliding of the O-ring 200 along the frustum portion 1011.

In some embodiments, to facilitate gripping of the operation component 102 to the guiding component 101, the guiding component 101 may further comprise a gripped portion 1013 extending from a small end 1014 of the frustum portion 1011, as shown in FIGS. 3 and 4. The gripped portion 1013 may be used for the operation component 102 in the first posture to grip to drive the guiding component 101 to rotate. This arrangement allows the guiding component 101 to be driven more easily and stably.

It should be understood that the above embodiments where the operation component 102 in the first posture clamps the gripped portion 1013 to rotate the guiding component 101 are merely for illustration, without suggesting any limitation as to the scope of the present application. Any suitable structures or arrangements are possible. In some alternative embodiments, the guiding component 101 may also be gripped from the inside of the guiding component by the operation component 102 in the second posture. In those embodiments, the operation component 102 may be inserted into a hole of the guiding component 101 and squeeze an inner surface of the hole to drive the operation component 102. In this way, the gripped portion 1013 may be omitted.

In some embodiments, all the operations of loading the O-ring into the groove 302 on end face 301 can be done by the operation component 102 in the second posture. For example, the O-ring 200 may be picked up by being expanded from the inside by the operation component 102 in the second posture. Then the guiding component 101 may also be driven to rotate by the operation component 102 in the second posture, for example by squeezing the inner surface of the hole of the guiding component 101. That is, the operation component 102 may be operated without changing posture thereof, reducing the difficulty of controlling the operation component 102.

In some embodiments, to ensure the entire O-ring 200 to be well received in the groove 302 and/or to fine-tune the posture of the O-ring in the groove 302, a roller 1023 arranged at a free end of each of the first and second gripping portions 1021, 1022 may be provided.

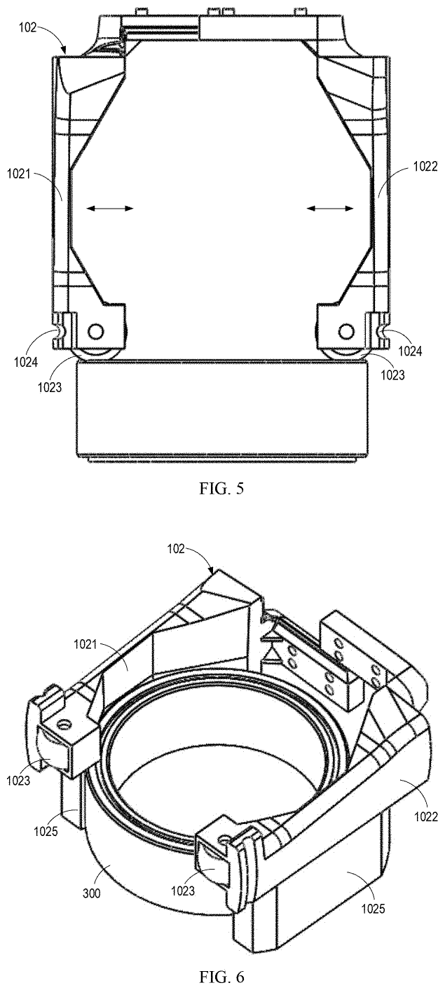

In operation, after the most of the O-ring 200 or the entire O-ring 200 slides into the groove 302 with the rotation of the guiding component 101, the guiding component 101 may be removed from the work piece 300 by the operation component 102 in the first posture. After that, the operation component 102 may be controlled to move from the first posture to the second posture as shown in FIG. 5. In this way, the rollers 1023 will press across the groove 302. With the movements of the first and second gripping portions 1021, 1022, the rollers 1023 can rotate back and forth.

In this event, if a part of O-ring 200 is not well received in the groove 302, the rotation of the rollers 1023 can press or push the part of the O-ring 200 to be well received in the groove 302. Furthermore, the operation component 102 in the second posture may also be driven to rotate about the central axis X and/or about the axis that is perpendicular to the central axis X. After that, with the further movements of the first and second gripping portions 1021, 1022, the rollers 1023 can rotate back and forth to press another part of the O-ring 200. The above steps can be repeated until the entire O-ring 200 is pressed. As a result, it can be ensured that the entire O-ring 200 is well received in the groove 302.

In some embodiments, the operation component 102 may also comprise additional parts 1025 each arranged below the first and second gripping portions 1021, 1022, as shown in FIG. 6. After the O-ring 200 has been well received in the groove 302, the work piece 300 may be clamped or moved to a required location by the additional part 1025. It is to be understood that the additional parts 1025 may also be omitted in some alternative embodiments. The work piece 300 with the O-ring 200 may also be picked up by the first and second gripping portions 1021, 1022 directly.

It can be seen from the above that the O-ring 200 can be picked up and can be well received in the groove 302 by the apparatuses 100 which is controlled by a robot automatically. That is, the entire operations of mounting the O-ring 200 in the groove 302 can be achieved by the robot being programmed without human intervention, thereby improving the efficiency and accuracy.

Embodiments of the present disclosure further provide a robot as mentioned above. The robot comprises an end effector that can operate the apparatus 100 as mentioned above to mount the O-ring 200 to a work piece 300. In this way, the O-ring 200 can be mounted into the groove 302 formed on an end surface 301 of the work piece 300 in an automated manner without human intervention, thereby improving the efficiency and accuracy. In some embodiments, as mentioned above, the operation component 102 of the apparatus 100 may be operated by the end effector or may be a part of the end effector.

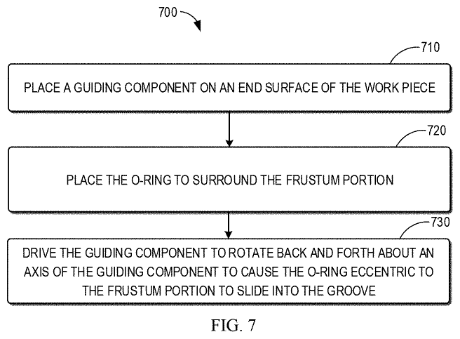

Embodiments of the present disclosure further provide a method for mounting an O-ring 200 to a work piece 300. FIG. 7 shows a flowchart 700 illustrating the method. As shown, in block 710, a guiding component 101 is placed on an end surface 301 of the work piece 300, for example by the operation component 102. The guiding component 101 has a frustum portion 1011 arranged coaxially with a groove 302 formed on the end surface 301 and a large end face 1012 of the frustum portion 1011 arranged adjacent to the end surface.

In block 720, an O-ring 200 is placed to surround the frustum portion 1011. After that, in block 730, the guiding component 101 is driven by the operation component 102 to rotate back and forth about the central axis X of the guiding component 101 to cause the O-ring 200 eccentric to the frustum portion 1011 to slide into the groove 302. In some embodiments, the guiding component 101 may also be driven by the operation component 102 to oscillate about an axis that is perpendicular to the central axis X. In this way, the O-ring 200 may also slide into the groove 302.

In some embodiments, the method further comprises removing the guiding component 101 with the operation component 102 from the end surface 301 after the O-ring 200 is at least partially received in the groove 302. Then the operation component 102 is moved from the first posture to the second posture. In the second posture, the rollers 1023 of the operation component 102 press across the groove 302. After that, the first and second gripping portions 1021, 1022 is moved towards each other to rotate the rollers 1023 to causing the O-ring 200 to be well received in the groove 302.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be comprised in the scope of protection of the present disclosure. Meanwhile, appended claims of the present disclosure aim to cover all the variations and modifications falling under the scope and boundary of the claims or equivalents of the scope and boundary.

1. An apparatus for mounting an O-ring to a work piece, comprising:
a guiding component comprising a frustum portion arranged coaxially with a groove formed on an end surface of the work piece for receiving the O-ring, a large end face of the frustum portion arranged adjacent to the end surface; and
an operation component adapted to drive the guiding component to rotate back and forth about a central axis (X) of the guiding component or to oscillate about an axis that is perpendicular to the central axis (X),
wherein a diameter (D) of the large end face is substantially same as an inner diameter (I) of the O-ring to allow the O-ring surrounding and eccentric to the frustum portion to slide into the groove with a rotation of the guiding component.

2. The apparatus of claim 1, wherein the guiding component further comprises a gripped portion extending from a small end of the frustum portion, and the gripped portion is adapted to be gripped by the operation component to drive the guiding component.

3. The apparatus of claim 2, wherein the operation component comprises a first gripping portion and a second gripping portion adapted to be driven to move towards each other to grip the gripped portion in a first posture of the operation component.

4. The apparatus of claim 3, wherein the operation component further comprises a roller arranged at a free end of each of the first and second gripping portions, and
the operation component is operable to move from the first posture to a second posture where the roller presses across the groove and is operable to rotate upon movements of the first and second gripping portions towards each other, to cause the entire O-ring to be received in the groove.

5. The apparatus of claim 3, wherein an operation surface of at least one of the first and second gripping portions for contacting the gripped portion is of a concave shape or a flat shape.

6. The apparatus of claim 1, wherein a slope of the frustum portion is configured to allow the O-ring that has been placed on the frustum portion to slide along the frustum portion against frictional force as the guiding component rotates back and forth.

7. The apparatus of claim 1, wherein the guiding component further comprises an aligning portion for aligning the guiding component with the work piece.

8. A robot comprising:
an end effector adapted to operate the apparatus according to claim 1 to mount an O-ring to a work piece.

9. The robot of claim 8, wherein an operation component of the apparatus is a part of the end effector.

10. A method for mounting an O-ring to a work piece, comprising:
placing a guiding component on an end surface of the work piece, with a frustum portion arranged coaxially with a groove formed on the end surface and a large end face of the frustum portion arranged adjacent to the end surface;
placing the O-ring to surround the frustum portion; and
driving the guiding component by the operation component to rotate back and forth about a central axis (X) of the guiding component or to oscillate about an axis that is perpendicular to the central axis (X) to cause the O-ring eccentric to the frustum portion to slide into the groove.

11. The method of claim 10, further comprising:
removing the guiding component from the end surface after the O-ring is at least partially received in the groove;
moving the operation component from a first posture to a second posture where a roller of the operation component presses across the groove; and
moving the first and second gripping portions towards each other to rotate the roller to cause the entire O-ring to be received in the groove.

12. A robot comprising:
an end effector adapted to operate the apparatus according to claim 2 to mount an O-ring to a work piece.

13. A robot comprising:
an end effector adapted to operate the apparatus according to claim 3 to mount an O-ring to a work piece.

14. A robot comprising:
an end effector adapted to operate the apparatus according to claim 4 to mount an O-ring to a work piece.

15. A robot comprising:
an end effector adapted to operate the apparatus according to claim 5 to mount an O-ring to a work piece.

16. A robot comprising:
an end effector adapted to operate the apparatus according to claim 6 to mount an O-ring to a work piece.

17. A robot comprising:
an end effector adapted to operate the apparatus according to claim 7 to mount an O-ring to a work piece.
